(19) United States
(12) Patent Application Publication
(10) Pub. No.: US 2026/0081431 A1
(43) Pub. Date: Mar. 19, 2026

(54) ELECTRIC POWER STORAGE SYSTEM

(71) Applicant: TOYOTA JIDOSHA KABUSHIKI KAISHA, Toyota-shi (JP)

(72) Inventors: Kazutaka KIMURA, Mishima-shi (JP); Mikikane HIROHATA, Sunto-gun (JP)

(73) Assignee: TOYOTA JIDOSHA KABUSHIKI KAISHA, Toyota-shi (JP)

(21) Appl. No.: 19/324,481

(22) Filed: Sep. 10, 2025

(30) Foreign Application Priority Data
Sep. 17, 2024 (JP) 2024-160113

(51) Int. Cl. H02J 7/14; H02J 3/38; H02J 15/00

(52) U.S. Cl. CPC H02J 7/14; H02J 3/381; H02J 15/30; H02J 15/50; H02J 2101/28; H02J 2207/50

(57) ABSTRACT

An electric power storage system is provided with: an electric power supplier that is configured to supply at least a portion of electric power generated by repeatedly alternating unwinding and winding of a tether that moors a flying body to an electric power storage unit, which stores electric power in a predetermined manner, and an electric power holding unit, which is capable of charging and discharging electric power; and a controller that is configured to control the electric power holding unit so that electric power is supplied from the electric power holding unit to the electric power storage unit during winding the tether.

### INCORPORATION BY REFERENCE

This application is based upon and claims the benefit of priority from Japanese Patent Application No. 2024-160113, filed on Sep. 17, 2024, the disclosure of which is incorporated herein in its entirety by reference.

### TECHNICAL FIELD

Embodiments of the present disclosure relate to technical fields of an electric power storage system.

### BACKGROUND ART

For example, JP 2020-094521 A as Patent Literature 1 discloses an electric power distribution management system, as this type of system, that switches wiring of power grid based on the maximum possible power of a plurality of power generation apparatuses that perform wind power generation using kite-type flying bodies and a target power required by each of a plurality of power demand devices

Since power generation using renewable energy, such as wind power generation, is susceptible to weather conditions, it is difficult to control the amount of electric power to be generated. For example, to prevent excess electric power from being wasted, it is performed to store excess electric power. As one example of storing electric power, it is performed to store electric power as hydrogen by converting electric power into hydrogen through electrolysis of water.

By the way, in wind power generation using a kite-type flying bodies, electric power is generated during rising a kite-type flying body due to wind, but electric power is not generated during the kite-type flying body is collected. In wind power generation using kite-type flying bodies, the output during electric power generation is significantly larger than the time-average of the output of during electric power generation and the output during collecting a kite-type flying body. In a case where electrolyze water is performed using electric power of wind power generation using kite-type flying bodies, an apparatus capable of handling the output during electric power generation is required. In other words, in this case, there is a technical problem in that an apparatus with a rated output significantly larger than the time-averaged output of wind power generation using kite-type flying bodies is required.

### SUMMARY

In view of the above-described problems, it is an object of the present disclosure to provide an electric power storage system that suppresses a rated output of an apparatus.

An electric power storage system according to an aspect of this discloser is an electric power storage system provided with: an electric power supplier that is configured to supply at least a portion of electric power generated by repeatedly alternating unwinding and winding of a tether that moors a flying body to an electric power storage unit, that stores electric power in a predetermined manner, and an electric power holding unit, that is capable of charging and discharging electric power; and a controller that is configured to control the electric power holding unit so that electric power is supplied from the electric power holding unit to the electric power storage unit during winding the tether.

### BRIEF DESCRIPTION OF THE DRAWINGS

FIG. 1 is a conceptual diagram illustrating an example of a power generation system;

FIG. 2 is a conceptual diagram illustrating an example of a power generation floating body;

FIG. 3 is a block diagram illustrating an example of configuration of the power generation floating body;

FIG. 4A is a graph illustrating an example of change in power generation output over time;

FIG. 4B is a graph illustrating an example of change in power generation output over time; and

FIG. 5 is a block diagram illustrating another example of configuration of a power generation floating body.

### EMBODIMENT

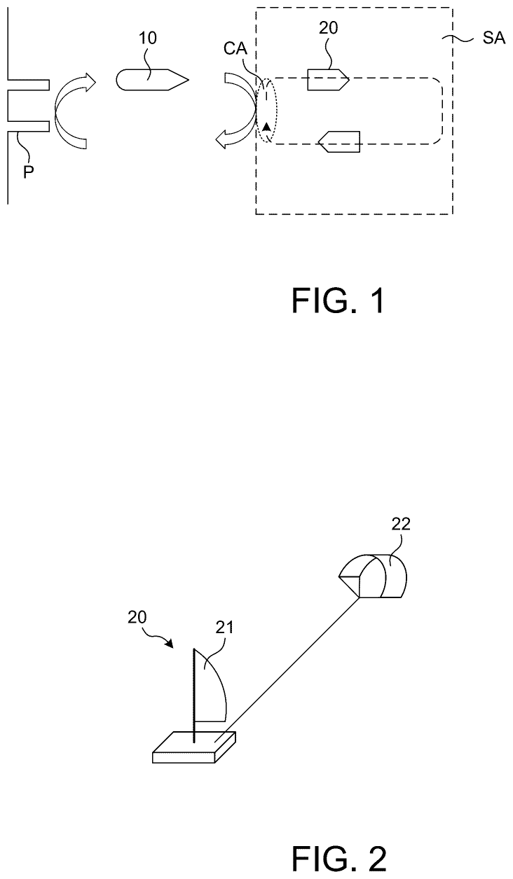

An embodiment of an electric power storage system will be described with reference to FIG. 1 to FIG. 4.

### Power Generation System

A power generation system will be described with reference to FIG. 1. The power generation system comprises a transport ship 10 and power generation floating bodies 20. In this power generation system, power is generated in a sea area SA relatively far from land using the power generation floating bodies 20 that do not require mooring. The power generation floating bodies 20 automatically sail within the sea area SA. That is, each of the power generation floating bodies 20 generates electricity while automatically sailing within the sea area SA.

The number of power generation floating bodies 20 that automatically sail within the sea area SA may be determined according to the power generation scale of the power generation system. For example, there may be hundreds to thousands of power generation floating bodies 20 within the sea area SA. For example, the sea area SA may be a sea area located 50 kilometers away from land. For example, the length of one side of the sea area SA may be tens of kilometers. Note that the shape of the sea area SA is not limited to a rectangular shape.

The transport ship 10 sails between a port P located on land and the sea area SA. For example, the transport ship 10 may collect energy generated by the power generation floating bodies 20 near the edge of the sea area SA (e.g., in the area CA). Subsequently, the transport ship 10 transports the collected energy from the power generation floating bodies 20 to the port P. In this way, the power generation system performs offshore power generation using power generation floating bodies 20 and energy transportation using the transport ship 10.

### Power Generation Floating Body 20

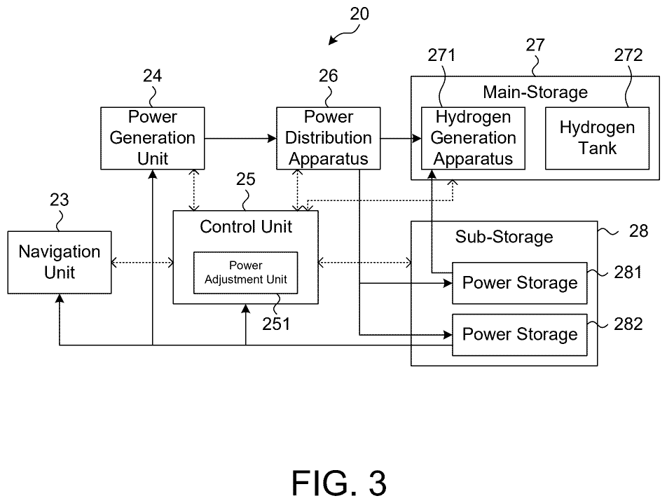

The power generation floating body 20 will be further described with reference to FIG. 2 and FIG. 3. In FIG. 2, the power generation floating body 20 is provided with a sail 21 and a kite 22. The power generation floating body 20 may utilize wind energy received by the sail 21 as propulsive power. The power generation floating body 20 may also utilize wind energy received by the kite 22 as propulsive power. In FIG. 3, the power generation floating body 20 is provided with a navigation unit 23, a power generation unit 24, a control unit 25, a power distribution apparatus 26, a main-storage 27, and a sub-storage 28. In FIG. 3, solid arrows indicate the flow of electricity, and dashed arrows indicate the flow of data.

The navigation unit 23 may include one or more elements for automatically sailing the power generation floating body 20. For example, the navigation unit 23 may include a mechanism for changing the orientation of the sail 21. For example, the navigation unit 23 may include at least one of a rudder for determining the direction of the hull of the power generation floating body 20 and a centerboard for generating lateral force. For example, the navigation unit 23 may include sensors necessary for sail. For example, the sensors may include at least one of a wind direction and wind speed sensor, a wind volume sensor, an acceleration sensor, an angular velocity sensor, and a speed sensor. Incidentally, the power generation floating body 20 may utilize electrical energy as propulsion power in addition to wind energy. In this case, the navigation unit 23 may include a screw propeller and a motor for driving the screw propeller.

The power generation unit 23 includes a winch for mooring the kite 22, a motor for rotating the drum of the winch, and a generator. In the power generation floating body 20, as the kite 22 rises, the tether securing the kite 22 is released from the winch. The rotation of the winch drum is caused by the release of the tether. As the drum rotates, the generator rotates, thereby generating electricity. When the tether is released to a predetermined length or a predetermined time has elapsed, the motor of the winch rotates the drum in the direction of winding the tether. As a result, the kite 22 descends due to the tether winding operation. In the power generation floating body 20, power generation is performed by repeatedly performing the tether release operation and the tether winding operation. In other words, tether-type wind power generation is performed in the power generation floating body 20.

The control unit 25 controls various processes in the power generation floating body 20. For example, the control unit 25 may be configured as a unit including a CPU (central processing unit) and a storage apparatus and an input/output interface necessary for the operation of the CPU. The storage apparatus may include, for example, a ROM (read-only memory), a RAM (random access memory), and a data storage. For example, the control unit 25 may be connected to the navigation unit 23, the power generation unit 24, the power distribution apparatus 26, the main-storage 27, and the sub-storage 28 via a data bus. For example, the control unit 25 may send control instructions to the navigation unit 23, the power generation unit 24, the power distribution apparatus 26, the main-storage 27, and the sub-storage 28 via a data bus. For example, the control unit 25 may acquire various information from the navigation unit 23, the power generation unit 24, the power distribution apparatus 26, the main-storage 27, and the sub-storage 28 via the data bus.

Incidentally, it has been found through the inventors'research that when the tether is deployed (i.e., during power generation), the power generation floating body 20 moves toward the windward side, and when the tether is retrieved, the power generation floating body 20 moves toward the leeward side, thereby increasing the net power generation. Therefore, the control unit 25 may control the navigation unit 23 so that the power generation floating body 20 moves toward the windward side when the tether is deployed and toward the leeward side when the tether is retrieved.

For example, a computer program for performing processing in the control unit 25 may be stored in at least one of the ROM and the data storage. The control unit 25 may read the computer program stored in at least one of the ROM and the data storage. The control unit 25 may obtain the computer program from an apparatus (not shown) disposed outside the power generation floating body 20 via a communication unit (not shown). The control unit 25 may execute the read computer program. As a result, logical functional blocks for controlling various processes in the power generation floating body 20 may be realized within the control unit 25. For example, a power adjustment unit 251 may be realized as a functional block within the control unit. Details of the operation of the power adjustment unit 251 will be described later.

The power distribution apparatus 26, the main-storage 27, and the sub-storage 28 constitute the power storage system according to this embodiment. The electric power obtained by tethered wind power generation using the kite 22 is distributed to the main-storage 27 and the sub-storage 28 through the power distribution apparatus 26. In other words, the power distribution apparatus 26 distributes the electric power obtained by tethered wind power generation to the main-storage 27 and the sub-storage 28.

The main-storage 27 has a hydrogen generation apparatus 271 and a hydrogen tank 272. The hydrogen generation apparatus 271 electrolyzes water using electric power (i.e., electrical energy) supplied through the power distribution apparatus 26. As a result, hydrogen is generated. The hydrogen generation apparatus 271 stores the hydrogen in the hydrogen tank 272. The hydrogen may be stored in the hydrogen tank 272 as compressed hydrogen or liquefied hydrogen. The hydrogen tank 272 may contain a hydrogen storage alloy. In this case, the hydrogen may be stored in the hydrogen tank 272 by being absorbed by the hydrogen storage alloy. The hydrogen tank 272 may store not only hydrogen but also hydrogen compounds. The hydrogen compounds may be ammonia, methylcyclohexane, etc. In this case, the main-storage 27 may have an apparatus for generating hydrogen compounds in addition to the hydrogen generation apparatus 271.

Incidentally, the transport ship 10 may collect the hydrogen tank 272 containing hydrogen or hydrogen compounds from the power generation floating body 20. The transport ship 10 may load an empty hydrogen tank (corresponding to the hydrogen tank 272) onto the power generation floating body 20. The hydrogen generation apparatus 271 may store hydrogen or a hydrogen compound in the empty hydrogen tank. In this way, in the present embodiment, the transport ship 10 may collect the energy obtained by power generation from the power generation floating body 20 by collecting the hydrogen tank 272. In other words, in the present embodiment, hydrogen or a hydrogen compound may be used as an energy carrier.

The sub-storage 28 has power storages 281 and 282. The power storage 281 is an apparatus for temporarily storing electric power used in the main-storage 27 (e.g., hydrogen generation apparatus 271). The power storage 281 may be an electric double-layer capacitor (which may be referred to as a “supercapacitor” or “ultracapacitor”) or a flywheel battery. The power storage 282 is an apparatus that stores the electric power necessary for the operation of the power generation floating body 20. The power storage 282 may be a secondary battery such as a lithium-ion battery or a NAS battery. The power storage 282 may supply power to the navigation unit 23, the power generation unit 24 (e.g., a motor capable of rotating the winch drum), and the control unit 25. Incidentally, electric double-layer capacitors and flywheel batteries have a longer cycle life compared to secondary batteries. Therefore, the power storage 281 can be said to be a power storage device with a longer cycle life compared to power storage 282.

### Time Variation of Power in the Power Generation Floating Body 20

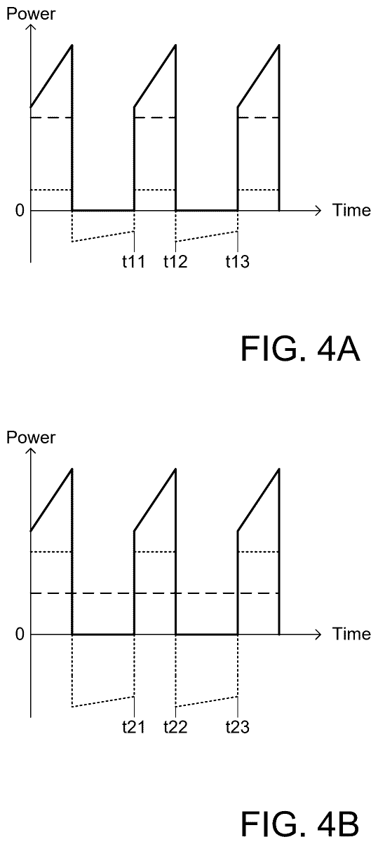

The time variation of power in the power generation floating body 20 will be described with reference to FIG. 4A and FIG. 4B. FIG. 4A illustrates an example of the time variation of power in the comparative example. FIG. 4B is an example of the time change in electric power according to the present embodiment. In FIG. 4A and FIG. 4B, the solid line indicates the time change in electric power for tethered wind power generation, the dotted line indicates the time change in electric power for sub-storage 28, and the broken line indicates the time change in electric power supplied to hydrogen generation apparatus 271. When the power related to the sub-storage 28 is negative, it indicates that the power output from the sub-storage 28 is greater than the power supplied to the sub-storage 28.

The power storage system of the comparative example does not include the power storage 281. For example, during the first period from time t11 to time t12 in FIG. 4A, power may be generated by power generation accompanying the ascent of the kite 22. During the second period from time t12 to time t13, the kite 22 may be collected. Therefore, the power generated during the second period is zero. Additionally, during the second period, power is supplied from the sub-storage 28 (specifically, the power storage 282) to the motor of the power generation unit 24 for retrieving the kite 22, so the power associated with the sub-storage 28 becomes a negative value.

The power generated during the first period is distributed between the main-storage 27 and the sub-storage 28. For example, 2 MW (megawatts) of electric power may be supplied to the main-storage 27, and 0.5 MW of electric power may be supplied to the sub-storage 28. The hydrogen generating apparatus 271 is required to be a hydrogen generating apparatus that can operate appropriately with the electric power supplied to the main-storage 27 in the first period. For example, the time-averaged output of tethered wind power generation using kite 22 may be 1 MW. In this case, the electric power supplied to main-storage 27 during the first period is significantly larger than the time-averaged output of wind power generation. Therefore, in the power storage system according to the comparative example, there is a technical problem in that a hydrogen generator with a rated output significantly larger than the time-averaged output of wind power generation is required.

The power storage system according to the present embodiment will be described with reference to FIG. 4B. For example, in the third period from time t21 to time t22 in FIG. 4B, power may be generated by power generation accompanying the rise of the kite 22. In the fourth period from time t22 to time t23, the kite 22 may be collected. The power generated during the third period is distributed between the main-storage 27 and the sub-storage 28. For example, 1 MW of power may be supplied to the main-storage 27, 1 MW of power may be supplied to the power storage 281 of the sub-storage 28, and 0.5 MW of power may be supplied to the power storage 282 of the sub-storage 28. For example, in the fourth period, 1 MW of power may be supplied from the power storage 281 to main-storage 27. In this case, the control unit 25 may control the power storage 281 so that power is supplied from the power storage 281 to main-storage 27 during the fourth period.

In this embodiment, during the third period, the power used by the main-storage 27 is temporarily stored in the power storage 281 of the sub-storage 28. For this reason, the power supplied to the main-storage 27 can be suppressed during the third period. As a result, the rated output of the hydrogen generating apparatus 271 can be suppressed.

### Power Adjustment Unit 251

The operation of the power adjustment unit 251 will be described below. The power adjustment unit 251 may predict the power demand in the power generation floating body 20. The power demand may be the amount of power required for the operation of the power generation floating body 20. The power adjustment unit 251 may acquire the power storage information of the power storage 282 of the sub-storage 28. For example, the stored power information may indicate at least one of the stored power amount and the stored power rate of the power storage 282. For example, the power adjustment unit 251 may determine the amount of power to be supplied to the power storage 282 as the difference between the predicted power demand and the stored power amount of the power storage 282.

For example, the power adjustment unit 251 may determine the amount of electric power to be supplied to the main-storage 27 based on the rated output of the hydrogen generating apparatus 271. For example, the power adjustment unit 251 may determine the amount of power to be supplied to the sub-storage 281 of the power storage 282 as the amount of power to be supplied to the sub-storage 28, which exceeds the sum of the amount of power to be supplied to the main-storage 27 and the amount of power to be supplied to the power storage 282 from the amount of power obtained from the tethered wind power generation. Thereafter, the power adjustment unit 251 may control the power distribution apparatus 26 so that the determined amount of electric power is supplied to the main-storage 27, the power storage 281, and the power storage 282.

### Technical Effect

As described with reference to FIG. 4A, in the electric power storage system according to the comparative example, power is supplied to the hydrogen generating apparatus 271 during power generation by the tethered wind power generator, while no power is supplied to the hydrogen generating apparatus 271 during recovery of the kite 22 (i.e., during non-power generation). For this reason, in the electric power storage system according to the comparative example, the rated output of the hydrogen generation apparatus 271 is relatively large.

In contrast, in the electric power storage system according to the present embodiment, when power is generated by tethered wind power generation, the power that can be used by the main-storage 27 is temporarily stored in the power storage 281 of the sub-storage 28, and when no power is generated, power is supplied from the power storage 281 to the main-storage 27. For this reason, the electric power storage system according to the present embodiment can smooth the power supplied to the main-storage 27. As a result, the rated output of the hydrogen generation apparatus 271 can be suppressed. Here, the price of the hydrogen generation apparatus 271 is directly proportional to its rated output. For example, by suppressing the rated output of the hydrogen generation apparatus 271, the manufacturing cost of the power generation floating body 20 can be suppressed.

For example, the period from time t21 to time t23 in FIG. 4B is tens of seconds to hundreds of seconds. That is, one cycle of charging and discharging of the power storage 281 of the sub-storage 28 is also tens of seconds to hundreds of seconds. As described above, the power storage 281 may be an electric double-layer capacitor or a flywheel battery. By configuring it in this way, the cycle life of the power storage 281 can be relatively prolonged. As a result, the operational costs of the power generation system can be suppressed.

### Modified Example

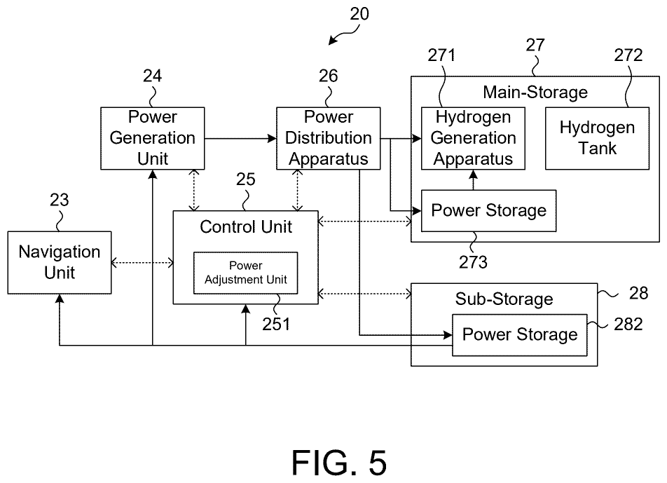

A modified example of the electric power storage system according to the above embodiment will be described with reference to FIG. 5. In FIG. 5, the main-storage 27 of the modified example has the hydrogen generation apparatus 271, the hydrogen tank 272, and the power storage 273. The power storage 273 is a power storage corresponding to the power storage 281 described above. In other words, the power storage 273 is an apparatus for temporarily storing the electric power used by the hydrogen generating apparatus 271. In FIG. 5, the sub-storage 28 of the modified example has the power storage 282. In other words, the sub-storage 28 of the modified example does not have the power storage 281.

For example, during the third period from time t21 to time t22 in FIG. 4B, power may be generated by power generation accompanying the ascent of kite 22. During the fourth period from time t22 to time t23, kite 22 may be collected. The electric power obtained by power generation in the third period is distributed to the main-storage 27 and the sub-storage 28. For example, 1 MW of electric power may be supplied to the hydrogen generation apparatus 271 of the main-storage 27, 1 MW of electric power may be supplied to the electric power storage 273 of the main-storage 27, and 0.5 MW of electric power may be supplied to the electric power storage 282 of the sub-storage 28. For example, in the fourth period, 1 MW of electric power may be supplied from the electric power storage 273 to the hydrogen generation apparatus 271. According to the electric power storage system according to the modified example, the rated output of the hydrogen generation apparatus 271 can be suppressed in the same manner as in the electric power storage system according to the above embodiment.

In the above embodiment, tethered wind power generation performed offshore was mentioned, but the power storage system according to the present invention can also be applied to tethered wind power generation performed on land.

The aspects of the invention derived from the embodiments and modified examples described above are described below.

An electric power storage system according to one aspect of the invention is an electric power storage system comprising: an electric power supplier that is configured to supply at least a portion of electric power generated by repeatedly alternating unwinding and winding of a tether that moors a flying body to an electric power storage unit, that stores electric power in a predetermined manner, and an electric power holding unit, that is capable of charging and discharging electric power; and a controller that is configured to control the electric power holding unit so that electric power is supplied from the electric power holding unit to the electric power storage unit during winding the tether.

In the above-mentioned embodiment, the “kite 22” corresponds to one example of the “flying body”; the “hydrogen generation apparatus 271” and the “hydrogen tank 272” correspond to one example of the “electric power storage unit”; the “power storage 281” and the “power storage 273” correspond to one example of the “electric power holding unit”; and the “control unit 25”corresponds to the “controller”.

In the electric power storage system, the flying body may be moored to a floating body capable of sailing on water via the tether.

In this aspect, the electric power storage system may comprise a main-storage system having the electric power storage unit, and a sub-storage system that is capable of charging and discharging electric power used for operating the floating body, wherein the sub-storage system may have the electric power holding unit. Incidentally, in the above-mentioned embodiment, the “main-storage 27” corresponds to one example of the “main-storage system”; and the “sub-storage 28”corresponds to one example of the “sub-storage system”.

Alternately, the electric power storage system may comprise a main-storage system having the electric power storage unit, and a sub-storage system that is capable of charging and discharging electric power used for operating the floating body, wherein the main-storage system may have the electric power holding unit.

In the electric power storage system, the electric power holding unit may be an electric double-layer capacitor or a flywheel battery.

The present disclosure is not limited to the above-described examples and is allowed to be changed, if desired, without departing from the essence or spirit of the invention which can be read from the claims and the entire specification. An electric power storage system with such changes is also included in the technical concepts of the present disclosure.

What is claimed is:

1. An electric power storage system comprising:
an electric power supplier that is configured to supply at least a portion of electric power generated by repeatedly alternating unwinding and winding of a tether that moors a flying body to an electric power storage unit, that stores electric power in a predetermined manner, and an electric power holding unit, that is capable of charging and discharging electric power; and
a controller that is configured to control the electric power holding unit so that electric power is supplied from the electric power holding unit to the electric power storage unit during winding the tether.

2. The electric power storage system according to claim 1, wherein
the flying body is moored to a floating body capable of sailing on water via the tether.

3. The electric power storage system according to claim 2, further comprising:
a main-storage system having the electric power storage unit; and
a sub-storage system that is capable of charging and discharging electric power used for operating the floating body,
wherein
the sub-storage system has the electric power holding unit.

4. The electric power storage system according to claim 2, further comprising:
a main-storage system having the electric power storage unit; and
a sub-storage system that is capable of charging and discharging electric power used for operating the floating body,
wherein
the main-storage system has the electric power holding unit.

5. The electric power storage system according to claim 1, wherein
the electric power holding unit is an electric double-layer capacitor or a flywheel battery.
